(19) United States
(12) Patent Application Publication
(10) Pub. No.: US 2024/0108070 A1
(43) Pub. Date: Apr. 4, 2024

(54) INDUCTOR COIL

(71) Applicant: NICOVENTURES TRADING LIMITED, London (GB)

(72) Inventor: Anton KORUS, London (GB)

(21) Appl. No.: 18/257,763

(22) PCT Filed: Dec. 22, 2021
(86) PCT No.: PCT/EP2021/087387

§ 371 Date: Jun. 15, 2023

(30) Foreign Application Priority Data
Dec. 22, 2020 (GB) 2020424.4

(51) Int. Cl. A24F 40/465; A24F 40/57; H01F 27/28; H05B 6/06; H05B 6/10; H05B 6/36; H05B 6/44; A24F 40/53

(52) U.S. Cl. CPC A24F 40/465; A24F 40/57; H01F 27/2885; H05B 6/06; H05B 6/108; H05B 6/362; H05B 6/44; A24F 40/53

(57) ABSTRACT

An inductor for use in an aerosol provision device is disclosed. The inductor includes an electrically-conductive element and a secondary coil. The element includes an electrically-conductive non-spiral first portion coincident with a first plane, an electrically-conductive non-spiral second portion coincident with a second plane that is spaced from the first plane, and an electrically-conductive connector that electrically connects the first portion to the second portion. The electrically-conductive element is configured such that when a varying electrical current is applied to the electrically-conductive element, a corresponding varying electrical current is induced in the secondary coil.

### PRIORITY CLAIM

The present application is a National Phase entry of PCT Application No. PCT/EP2021/087387, filed Dec. 22, 2021, which claims priority from GB Application No. 2020424.4, filed Dec. 22, 2020, each of which is hereby fully incorporated herein by reference.

### TECHNICAL FIELD

The present disclosure relates to inductors for use in aerosol provision devices, to magnetic field generators for use in aerosol provision devices, and to aerosol provision devices. The aerosol provision devices may be tobacco heating products, for example.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use induction heating systems as heaters to create an aerosol from a suitable medium. An induction heating system generally consists of a magnetic field generating device for generating a varying magnetic field, and a susceptor or heating material which is heatable by penetration with the varying magnetic field to heat the suitable medium.

Many different magnetic field generating devices are known, such as a three dimensional inductor coil. However, there are a variety of constraints, such as the available space, size of device, and power requirements, which places a restriction on the types of magnetic field generating devices. Furthermore, there are a variety of parameters which limit the efficiency of the inductive coupling between the magnetic field generating device and the susceptor. For example, such parameters include the separation between the magnetic field generating device and the susceptor or heating material, or the relative area sizes and orientations thereof.

It is desired to provide an improved aerosol provision device.

### SUMMARY

According to an aspect there is provided an inductor for use in an aerosol provision device, the inductor comprising an electrically-conductive element and a secondary coil; wherein the element comprises an electrically-conductive non-spiral first portion coincident with a first plane, an electrically-conductive non-spiral second portion coincident with a second plane that is spaced from the first plane, and an electrically-conductive connector that electrically connects the first portion to the second portion; and wherein the electrically-conductive element is configured such that when a varying electrical current is applied to the electrically-conductive element, a corresponding varying electrical current is induced in the secondary coil.

According to various embodiments the current induced across the secondary coil (or “sense coil”) may produce a corresponding voltage across the secondary coil which can be measured by a controller and which is proportional to the current flowing to the inductor. This means the voltage across the secondary coil may be recorded by the controller as a function of a drive frequency of the device. The controller on the basis of this measurement may calculate the temperature of a heating chamber, a susceptor or an aerosol generating article.

The controller may then cause a characteristic of the varying or alternating electrical current being applied to the inductor of at least one heating unit to be adjusted as necessary, in order to ensure that the temperature of the heating chamber, the susceptor or the aerosol generating article remains within a predetermined temperature range. The characteristic may be, for example, amplitude or frequency or duty cycle.

According to an aspect there is provided an inductor for use in an aerosol provision device, the inductor comprising: an electrically-conductive element and a secondary coil; wherein the element comprises an electrically-conductive first partial annulus coincident with a first plane, an electrically-conductive second partial annulus coincident with a second plane that is spaced from the first plane, and an electrically-conductive connector that electrically connects the first partial annulus to the second partial annulus; and wherein the electrically-conductive element is configured such that when a varying electrical current is applied to the electrically-conductive element, a corresponding varying electrical current is induced in the secondary coil.

According to an aspect there is provided an inductor for use in an aerosol provision device, the inductor comprising: an electrically-conductive element and electromagnetic shielding; wherein the element comprises an electrically-conductive non-spiral first portion coincident with a first plane, an electrically-conductive non-spiral second portion coincident with a second plane that is spaced from the first plane, and an electrically-conductive connector that electrically connects the first portion to the second portion; and wherein the electromagnetic shielding is arranged to at least partially surround at least one of the electrically-conductive non-spiral first portion coincident with the first plane, the electrically-conductive non-spiral second portion with the second plane and the electrically-conductive connector.

According to an aspect there is provided an inductor for use in an aerosol provision device, the inductor comprising: an electrically-conductive element and electromagnetic shielding; wherein the element comprises an electrically-conductive first partial annulus coincident with a first plane, an electrically-conductive second partial annulus coincident with a second plane that is spaced from the first plane, and an electrically-conductive connector that electrically connects the first partial annulus to the second partial annulus; and wherein the electromagnetic shielding is arranged to at least partially surround at least one of the electrically-conductive first partial annulus coincident with the first plane, the electrically-conductive second partial annulus coincident with the second plane and the electrically-conductive connector.

According to an aspect there is provided an inductor for use in an aerosol provision device, the inductor comprising: an electrically-conductive element; wherein the element comprises an electrically-conductive non-spiral first portion coincident with a first plane, an electrically-conductive non-spiral second portion coincident with a second plane that is spaced from the first plane, and an electrically-conductive connector that electrically connects the first portion to the second portion.

In an exemplary embodiment, the second plane is parallel to the first plane.

In an exemplary embodiment, the first portion is a first partial annulus and the second portion is a second partial annulus.

According to another aspect there is provided an inductor for use in an aerosol provision device, the inductor comprising: an electrically-conductive element; wherein the element comprises an electrically-conductive first partial annulus coincident with a first plane, an electrically-conductive second partial annulus coincident with a second plane that is spaced from the first plane, and an electrically-conductive connector that electrically connects the first partial annulus to the second partial annulus.

In an exemplary embodiment, the second plane is parallel to the first plane.

In an exemplary embodiment, the first portion or first partial annulus is a first circular arc, and the second portion or second partial annulus is a second circular arc.

In an exemplary embodiment, when viewed in a direction orthogonal to the first plane, the first and second portions or partial annuli extend in opposite senses of rotation from the electrically-conductive connector.

In an exemplary embodiment, when viewed in a direction orthogonal to the first plane, the first portion or first partial annulus overlaps, only partially, the second portion or second partial annulus.

In an exemplary embodiment, when viewed in a direction orthogonal to the first plane, the first portion or first partial annulus at least partially overlaps the electrically-conductive connector.

In an exemplary embodiment, the first and second planes are flat planes.

In an exemplary embodiment, a distance between the first and second planes measured in a direction orthogonal to the first and second planes is less than 2 millimeters. In an exemplary embodiment, the distance between the first and second planes is less than 1 millimeter.

In an exemplary embodiment, the first and second portions or partial annuli together define at least 0.9 turns about an axis that is orthogonal to the first and second planes.

In an exemplary embodiment, the element comprises further electrically-conductive non-spiral portions or electrically-conductive partial annuli that are coincident with respective spaced-apart planes.

In an exemplary embodiment, the spaced-apart planes are parallel to the first plane.

In an exemplary embodiment, a total number of turns, about an axis, defined by all of the electrically-conductive non-spiral portions or partial annuli of the element together is between one and ten. In an exemplary embodiment, the total number of turns is between one and eight. In an exemplary embodiment, the total number of turns is between one and four.

In an exemplary embodiment a distance between each adjacent pair of the portions or partial annuli of the element is equal to, or differs by less than 10% from, a distance between each other adjacent pair of the portions or partial annuli of the element.

In an exemplary embodiment, each of the first and second portions or partial annuli has a thickness, measured in a direction orthogonal to the first plane, of between 10 micrometers and 200 micrometers. In an exemplary embodiment, the thickness is between 25 micrometers and 175 micrometers. In an exemplary embodiment, the thickness is between 100 micrometers and 150 micrometers.

According to another aspect there is provided an inductor for use in an aerosol provision device, the inductor comprising a coil having a pitch of less than 2 millimeters.

In an exemplary embodiment, the pitch is less than 1 millimeter.

According to another aspect there is provided an inductor arrangement for use in an aerosol provision device, the inductor arrangement comprising: an electrically-insulating support having opposite first and second sides; and an inductor as disclosed above, wherein the first portion or first partial annulus is on the first side of the support, and the second portion or second partial annulus is on the second side of the support.

In an exemplary embodiment, the inductor arrangement has a through-hole that is radially-inward of, and coaxial with, the first and second portions or partial annuli.

In an exemplary embodiment, the electrically-conductive connector of the inductor extends through the support.

In an exemplary embodiment, the support has a thickness of between 0.2 millimeters and 2 millimeters. In an exemplary embodiment, the support has a thickness of between 0.5 millimeters and 1 millimeter. In an exemplary embodiment, the support has a thickness of between 0.75 millimeters and 0.95 millimeters.

In an exemplary embodiment, the inductor arrangement comprises a printed circuit board, wherein the support is a non-electrically-conductive substrate of the printed circuit board and the first and second portions or partial annuli are tracks on the substrate.

According to another aspect there is provided an inductor assembly for use in an aerosol provision device, the inductor assembly comprising plural inductors as disclosed above or comprising plural inductor arrangements as disclosed above.

According to an aspect there is provided a magnetic field generator for use in an aerosol provision device, the magnetic field generator comprising one or more inductors as disclosed above or one or more inductor arrangements as disclosed above or the inductor assembly disclosed above.

According to an aspect there is provided a magnetic field generator for use in an aerosol provision device, the magnetic field generator comprising one or more inductors and an apparatus that is operable to pass a varying electrical current through the one or more inductors, wherein the one or more inductors and the apparatus are configured to cause the generation of a magnetic field having a magnetic flux density of at least 0.01 Tesla. In an exemplary embodiment, the magnetic flux density is at least 0.1 Tesla.

In an exemplary embodiment, the, or each, inductor is as disclosed above, or the magnetic field generator comprises one or more inductor arrangements as disclosed above and the one or more inductors of the magnetic field generator are of the respective one or more inductor arrangements.

According to an aspect there is provided an aerosol provision device comprising: a heating zone for receiving at least a portion of an article comprising aerosolizable material; and a magnetic field generator as disclosed above, wherein the magnetic field generator is configured to be operable to generate a varying magnetic field for use in heating at least part of the aerosolizable material of the article when the article is in the heating zone.

In an exemplary embodiment, the, or each, inductor of the magnetic field generator at least partially encircles the heating zone.

In an exemplary embodiment, the aerosol provision device comprises a susceptor that is heatable by penetration with the varying magnetic field to thereby cause heating of the heating zone.

In an exemplary embodiment, the magnetic field generator is configured to be operable to generate plural respective varying magnetic fields independently of each other, for use in heating respective parts of the aerosolizable material of the article independently of each other.

According to an aspect there is provided an aerosol provision system, comprising an aerosol provision device as disclosed above and the article comprising aerosolizable material, wherein the article comprising aerosolizable material is at least partially insertable into the heating zone.

According to an aspect there is provided a magnetic field generator for use in an aerosol provision device, the magnetic field generator comprising one or more inductors, one or more coils and an apparatus that is operable to pass a varying electrical current through the one or more inductors; wherein when the apparatus passes a varying electrical current through the one or more inductors, a corresponding varying electrical current is induced in the one or more coils; and wherein the one or more inductors and the apparatus are configured to cause the generation of a magnetic field having a magnetic flux density of at least 0.01 Tesla.

According to an aspect there is provided a magnetic field generator for use in an aerosol provision device, the magnetic field generator comprising one or more inductors, an apparatus that is operable to pass a varying electrical current through the one or more inductors, and electromagnetic shielding; wherein the electromagnetic shielding is arranged between the one or more inductors and the apparatus, wherein the electromagnetic shielding is further arranged to at least partially surround the one or more inductors and/or the apparatus; and wherein the one or more inductors and the apparatus are configured to cause the generation of a magnetic field having a magnetic flux density of at least 0.01 Tesla.

### BRIEF DESCRIPTION OF THE DRAWINGS

Various embodiments will now be described, by way of example only, and with reference to the accompanying drawings, in which:

FIG. 1 shows a schematic side view of an example of an aerosol provision system;

FIG. 2 is a flow diagram showing an example of a method of heating aerosolizable material;

FIG. 3 is a flow diagram showing another example of a method of heating aerosolizable material;

FIG. 4 shows a schematic cross-sectional side view of an inductor arrangement of an aerosol provision device of the system of FIG. 1;

FIG. 5 shows a schematic perspective view of an inductor of the inductor arrangement of FIG. 4;

FIG. 6 shows an embodiment wherein an inductor element is provided comprising an electrically-conductive non-spiral first portion coincident with a first plane, an electrically-conductive non-spiral second portion coincident with a second plane that is spaced from the first plane and an electrically-conductive connector that electrically connects the first portion to the second portion;

FIG. 7 shows an electrical equivalence diagram showing how according to an embodiment a single sense element or coil may be considered as being located in close proximity to an inductor element or coil;

FIG. 8 shows an electrical equivalence diagram showing how according to an embodiment a single sense element or coil may be considered as being located in close proximity to two inductor elements or coils; and

FIG. 9 shows an electrical equivalence diagram showing how according to an embodiment two inductor elements or coils may be provided wherein each inductor element or coil has a corresponding sense element or coil.

### DETAILED DESCRIPTION

As used herein, the term “aerosolizable material” includes materials that provide volatilized components upon heating, typically in the form of vapor or an aerosol. “Aerosolizable material” may be a non-tobacco-containing material or a tobacco-containing material. “Aerosolizable material” may, for example, include one or more of tobacco per se, tobacco derivatives, expanded tobacco, reconstituted tobacco, tobacco extract, homogenized tobacco or tobacco substitutes. The aerosolizable material can be in the form of ground tobacco, cut rag tobacco, extruded tobacco, reconstituted tobacco, reconstituted aerosolizable material, liquid, gel, a solid, an amorphous solid, gelled sheet, powder, beads, granules, or agglomerates, or the like. “Aerosolizable material” also may include other, non-tobacco, products, which, depending on the product, may or may not contain nicotine. “Aerosolizable material” may comprise one or more humectants, such as glycerol or propylene glycol.

In some examples, the aerosolizable material is in the form of an “amorphous solid”. Any material referred to herein as an “amorphous solid” may alternatively be referred to as a “monolithic solid” (i.e. non-fibrous), or as a “dried gel”. It some cases, it may be referred to as a “thick film”. In some examples, the amorphous solid may consist essentially of, or consist of, a gelling agent, an aerosol generating agent, a tobacco material and/or a nicotine source, water, and optionally a flavor. In some examples, the gel or amorphous solid takes the form of a foam, such as an open celled foam.

A susceptor is material that is heatable by penetration with a varying magnetic field, such as an alternating magnetic field. The heating material may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The heating material may be both electrically-conductive and magnetic, so that the heating material is heatable by both heating mechanisms.

Induction heating is a process in which an electrically-conductive object is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating.

In one example, the susceptor is in the form of a closed circuit. It has been found that, when the susceptor is in the form of a closed circuit, magnetic coupling between the susceptor and the electromagnet in use is enhanced, which results in greater or improved Joule heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule heating.

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Moreover, as induction heating and magnetic hysteresis heating do not require a physical connection to be provided between the source of the varying magnetic field and the object, design freedom and control over the heating profile may be greater, and cost may be lower.

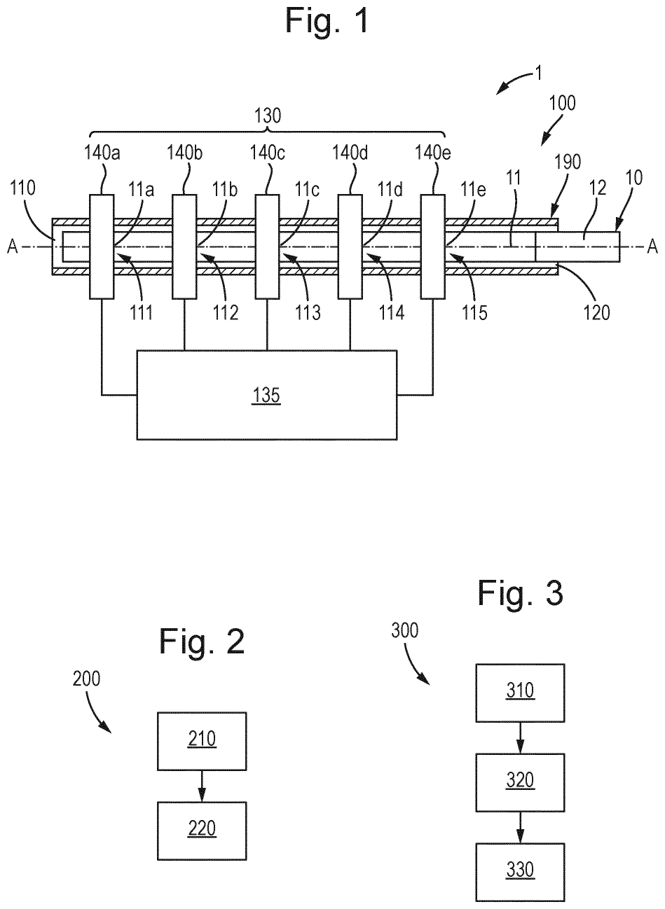

Referring to FIG. 1, there is shown a schematic cross-sectional side view of an example of an aerosol provision system. The system 1 comprises an aerosol provision device 100 and an article 10 comprising aerosolizable material 11. The aerosolizable material 11 may, for example, be of any of the types of aerosolizable material discussed herein. In this example, the aerosol provision device 100 is a tobacco heating product (also known in the art as a tobacco heating device or a heat-not-burn device).

In some examples, the aerosolizable material 11 is a non-liquid material. In some examples, the aerosolizable material 11 is a gel. In some examples, the aerosolizable material 11 comprises tobacco. However, in other examples, the aerosolizable material 11 may consist of tobacco, may consist substantially entirely of tobacco, may comprise tobacco and aerosolizable material other than tobacco, may comprise aerosolizable material other than tobacco, or may be free from tobacco. In some examples, the aerosolizable material 11 may comprise a vapor or aerosol forming agent or a humectant, such as glycerol, propylene glycol, triacetin, or diethylene glycol. In some examples, the aerosolizable material 11 comprises reconstituted aerosolizable material, such as reconstituted tobacco.

In some examples, the aerosolizable material 11 is substantially cylindrical with a substantially circular cross section and a longitudinal axis. In other examples, the aerosolizable material 11 may have a different cross-sectional shape and/or not be elongate.

The aerosolizable material 11 of the article 10 may, for example, have an axial length of between 8 mm and 120 mm. For example, the axial length of the aerosolizable material 11 may be greater than 9 mm, or 10 mm, or 15 mm, or 20 mm. For example, the axial length of the aerosolizable material 11 may be less than 100 mm, or 75 mm, or 50 mm, or 40 mm.

In some examples, such as that shown in FIG. 1, the article 10 comprises a filter arrangement 12 for filtering aerosol or vapor released from the aerosolizable material 11 in use. Alternatively, or additionally, the filter arrangement 12 may be for controlling the pressure drop over a length of the article 10. The filter arrangement 12 may comprise one, or more than one, filter. The filter arrangement 12 could be of any type used in the tobacco industry. For example, the filter may be made of cellulose acetate. In some examples, the filter arrangement 12 is substantially cylindrical with a substantially circular cross section and a longitudinal axis. In other examples, the filter arrangement 12 may have a different cross-sectional shape and/or not be elongate.

In some examples, the filter arrangement 12 abuts a longitudinal end of the aerosolizable material 11. In other examples, the filter arrangement 12 may be spaced from the aerosolizable material 11, such as by a gap and/or by one or more further components of the article 10. In some examples, the filter arrangement 12 may comprise an additive or flavor source (such as an additive- or flavor-containing capsule or thread), which may be held by a body of filtration material or between two bodies of filtration material, for example.

The article 10 may also comprise a wrapper (not shown) that is wrapped around the aerosolizable material 11 and the filter arrangement 12 to retain the filter arrangement 12 relative to the aerosolizable material 11. The wrapper may be wrapped around the aerosolizable material 11 and the filter arrangement 12 so that free ends of the wrapper overlap each other. The wrapper may form part of, or all of, a circumferential outer surface of the article 10. The wrapper could be made of any suitable material, such as paper, card, or reconstituted aerosolizable material (e.g. reconstituted tobacco). The paper may be a tipping paper that is known in the art. The wrapper may also comprise an adhesive (not shown) that adheres overlapped free ends of the wrapper to each other, to help prevent the overlapped free ends from separating.

In other examples, the adhesive may be omitted or the wrapper may take a different from to that described. In other examples, the filter arrangement 12 may be retained relative to the aerosolizable material 11 by a connector other than a wrapper, such as an adhesive. In some examples, the filter arrangement 12 may be omitted.

The aerosol provision device 100 comprises a heating zone 110 for receiving at least a portion of the article 10, an outlet 120 through which aerosol is deliverable from the heating zone 110 to a user in use, and heating apparatus 130 for causing heating of the article 10 when the article 10 is at least partially located within the heating zone 110 to thereby generate the aerosol. In some examples, such as that shown in FIG. 1, the aerosol is deliverable from the heating zone 110 to the user through the article 10 itself, rather than through any gap adjacent to the article 10. Nevertheless, in such examples, the aerosol still passes through the outlet 120, albeit while travelling within the article 10.

The device 100 may define at least one air inlet (not shown) that fluidly connects the heating zone 110 with an exterior of the device 100. A user may be able to inhale the volatilized component(s) of the aerosolizable material by drawing the volatilized component(s) from the heating zone 110 via the article 10. As the volatized component(s) are removed from the heating zone 110 and the article 10, air may be drawn into the heating zone 110 via the air inlet(s) of the device 100.

In this example, the heating zone 110 extends along an axis A-A and is sized and shaped to accommodate only a portion of the article 10. In this example, the axis A-A is a central axis of the heating zone 110. Moreover, in this example, the heating zone 110 is elongate and so the axis A-A is a longitudinal axis A-A of the heating zone 110. The article 10 is insertable at least partially into the heating zone 110 via the outlet 120 and protrudes from the heating zone 110 and through the outlet 120 in use. In other examples, the heating zone 110 may be elongate or non-elongate and dimensioned to receive the whole of the article 10. In some such examples, the device 100 may include a mouthpiece that can be arranged to cover the outlet 120 and through which the aerosol can be drawn from the heating zone 110 and the article 10.

In this example, when the article 10 is at least partially located within the heating zone 110, different portions 11a-11e of the aerosolizable material 11 are located at different respective locations 110a-110e in the heating zone 110. In this example, these locations 110a-110e are at different respective axial positions along the axis A-A of the heating zone 110. Moreover, in this example, since the heating zone 110 is elongate, the locations 110a-110e can be considered to be at different longitudinally-spaced-apart positions along the length of the heating zone 110. In this example, the article 10 can be considered to comprise five such portions 11a-11e of the aerosolizable material 11 that are located respectively at a first location 110a, a second location 110b, a third location 110c, a fourth location 110d and a fifth location 110e. More specifically, the second location 110b is fluidly located between the first location 110a and the outlet 120, the third location 110c is fluidly located between the second location 110b and the outlet 120, the fourth location 110d is fluidly located between the third location 110c and the outlet 120, and the fifth location is fluidly located between the fourth location 110d and the outlet 120.

The heating apparatus 130 comprises plural heating units 140a-140e, each of which is able to cause heating of a respective one of the portions 11a-11e of the aerosolizable material 11 to a temperature sufficient to aerosolize a component thereof, when the article 10 is at least partially located within the heating zone 110. The plural heating units 140a-140e may be axially-aligned with each other along the axis A-A. Each of the portions 11a-11e of the aerosolizable material 11 heatable in this way may, for example, have a length in the direction of the axis A-A of between 1 millimeter and 20 millimeters, such as between 2 millimeters and 10 millimeters, between 3 millimeters and 8 millimeters, or between 4 millimeters and 6 millimeters.

The heating apparatus 130 of this example comprises five heating units 140a-140e, namely: a first heating unit 140a, a second heating unit 140b, a third heating unit 140c, a fourth heating unit 140d and a fifth heating unit 140e. The heating units 140a-140e are at different respective axial positions along the axis A-A of the heating zone 110. Moreover, in this example, since the heating zone 110 is elongate, the heating units 140a-140e can be considered to be at different longitudinally-spaced-apart positions along the length of the heating zone 110. More specifically, the second heating unit 140b is located between the first heating unit 140a and the outlet 120, the third heating unit 140c is located between the second heating unit 140b and the outlet 120, the fourth heating unit 140d is located between the third heating unit 140c and the outlet 120, and the fifth heating unit 140e is located between the fourth heating unit 140d and the outlet 120. In other examples, the heating apparatus 130 could comprise more than five heating units 140a-140e or fewer than five heating units, such as only four, only three, only two, or only one heating unit. The number of portion(s) of the aerosolizable material 11 that are heatable by the respective heating unit(s) may be correspondingly varied.

The heating apparatus 130 also comprises a controller 135 that is configured to cause operation of the heating units 140a-140e to cause the heating of the respective portions 11a-11e of the aerosolizable material 11 in use. In this example, the controller 135 is configured to cause operation of the heating units 140a-140e independently of each other, so that the respective portions 11a-11e of the aerosolizable material 11 can be heated independently. This may be desirable in order to provide progressive heating of the aerosolizable material 11 in use. Moreover, in examples in which the portions 11a-11e of the aerosolizable material 11 have different respective forms or characteristics, such as different tobacco blends and/or different applied or inherent flavors, the ability to independently heat the portions 11a-11e of the aerosolizable material 11 can enable heating of selected portions 11a-11e of the aerosolizable material 11 at different times during a session of use so as to generate aerosol that has predetermined characteristics that are time-dependent. In some examples, the heating apparatus 130 may nevertheless also be operable in one or more modes in which the controller 135 is configured to cause operation of more than one of the heating units 140a-140e, such as all of the heating units 140a-140e, at the same time during a session of use.

In this example, the heating units 140a-140e comprise respective induction heating units that are configured to generate respective varying magnetic fields, such as alternating magnetic fields. As such, the heating apparatus 130 can be considered to comprise a magnetic field generator, and the controller 135 can be considered to be apparatus that is operable to pass a varying electrical current through inductors 150 of the respective heating units 140a-140e. Moreover, in this example, the device 100 comprises a susceptor 190 that is configured so as to be heatable by penetration with the varying magnetic fields to thereby cause heating of the heating zone 110 and the article 10 therein in use. That is, portions of the susceptor 190 are heatable by penetration with the respective varying magnetic fields to thereby cause heating of the respective portions 11a-11e of the aerosolizable material 11 at the respective locations 110a-110e in the heating zone 110.

In some examples, the susceptor 190 is made of, or comprises, aluminum. However, in other examples, the susceptor 190 may comprise one or more materials selected from the group consisting of: an electrically-conductive material, a magnetic material, and a magnetic electrically-conductive material. In some examples, the susceptor 190 may comprise a metal or a metal alloy. In some examples, the susceptor 190 may comprise one or more materials selected from the group consisting of: aluminum, gold, iron, nickel, cobalt, conductive carbon, graphite, steel, plain-carbon steel, mild steel, stainless steel, ferritic stainless steel, molybdenum, silicon carbide, copper, and bronze. Other material(s) may be used in other examples.

In some examples, such as those in which the susceptor 190 comprises iron, such as steel (e.g. mild steel or stainless steel) or aluminum, the susceptor 190 may comprise a coating to help avoid corrosion or oxidation of the susceptor 190 in use. Such coating may, for example, comprise nickel plating, gold plating, or a coating of a ceramic or an inert polymer.

In this example, the susceptor 190 is tubular and encircles the heating zone 110. Indeed, in this example, an inner surface of the susceptor 190 partially delimits the heating zone 110. An internal cross-sectional shape of the susceptor 190 may be circular or a different shape, such as elliptical, polygonal or irregular. In other examples, the susceptor 190 may take a different form, such as a non-tubular structure that still partially encircles the heating zone 110, or a protruding structure, such as a rod, pin or blade, that penetrates the heating zone 110. In some examples, the susceptor 190 may be replaced by plural susceptors, each of which is heatable by penetration with a respective one of the varying magnetic fields to thereby cause heating of a respective one of the portions 11a-11e of the aerosolizable material 11. Each of the plural susceptors may be tubular or take one of the other forms discussed herein for the susceptor 190, for example. In still further examples, the device 100 may be free from the susceptor 190, and the article 10 may comprise one or more susceptors that are heatable by penetration with the varying magnetic fields to thereby cause heating of the respective portions 11a-11e of the aerosolizable material 11. Each of the one or more susceptors of the article 10 may take any suitable form, such as a structure (e.g. a metallic foil, such as an aluminum foil) wrapped around or otherwise encircling the aerosolizable material 11, a structure located within the aerosolizable material 11, or a group of particles or other elements mixed with the aerosolizable material 11. In examples in which the device 100 is free from the susceptor 190, the susceptor 190 may be replaced by a heat-resistant tube that partially delimits the heating zone 110. Such a heat-resistant tube may, for example, be made from polyether ether ketone (PEEK) or a ceramic material.

In this example, the heating apparatus 130 comprises an electrical power source (not shown) and a user interface (not shown) for user-operation of the device. The electrical power source of this example is a rechargeable battery. In other examples, the electrical power source may be other than a rechargeable battery, such as a non-rechargeable battery, a capacitor, a battery-capacitor hybrid, or a connection to a mains electricity supply.

In this example, the controller 135 is electrically connected between the electrical power source and the heating units 140a-140e. In this example, the controller 135 also is electrically connected to the electrical power source. More specifically, in this example, the controller 135 is for controlling the supply of electrical power from the electrical power source to the heating units 140a-140e. In this example, the controller 135 comprises an integrated circuit (IC), such as an IC on a printed circuit board (PCB). In other examples, the controller 135 may take a different form. The controller 135 is operated in this example by user-operation of the user interface. The user interface may comprise a push-button, a toggle switch, a dial, a touchscreen, or the like. In other examples, the user interface may be remote and connected to the rest of the aerosol provision device 100 wirelessly, such as via Bluetooth.

In this example, operation of the user interface by a user causes the controller 135 to cause an alternating electrical current to pass through the inductor 150 of at least one of the respective heating units 140a-140e. This causes the inductor 150 to generate an alternating magnetic field. The inductor 150 and the susceptor 190 are suitably relatively positioned so that the varying magnetic field produced by the inductor 150 penetrates the susceptor 190. When the susceptor 190 is electrically-conductive, this penetration causes the generation of one or more eddy currents in the susceptor 190. The flow of eddy currents in the susceptor 190 against the electrical resistance of the susceptor 190 causes the susceptor 190 to be heated by Joule heating. When the susceptor 190 is magnetic, the orientation of magnetic dipoles in the susceptor 190 changes with the changing applied magnetic field, which causes heat to be generated in the susceptor 190.

The device 100 may also comprise a secondary (“sense”) coil (not shown) which may act as a sensing coil for sensing an induced varying electrical current through the secondary coil, induced when the electrical power source applies a varying electrical current to the inductor 150 of at least one of the respective heating units 140a-140e as controlled by the controller 135. Each inductor 150 of the respective heating units 140a-140e may have a respective secondary coil. In this example, when the controller 135 passes a varying electrical current through the inductor 150 of at least one of the respective heating unit's 140a-140e, the inductor 150 generates an alternating magnetic field. The alternating magnetic field generates eddy currents in the respective secondary coil, thereby inducing a varying electrical current in the secondary coil. The secondary coil may be positioned above or below the inductor 150, for example in a plane parallel to the inductor 150.

In other examples where there may be more than one inductor 150, the secondary coil may be placed between the inductors 150 such that both inductors 150 induce a varying electrical current through the secondary coil. However, in other examples where each of the heating units 140a-140e comprise more than one respective inductor 150, there may be a respective secondary coil for each respective inductor 150, so that each respective inductor 150 induces a varying electrical current into the respective secondary coil.

The current induced across the secondary coil produces a corresponding voltage across the secondary coil which can be measured by the controller 135 and is proportional to the current flowing to the inductor 150. This means the voltage across the secondary coil may be recorded by the controller 135 as a function of a drive frequency of the device. The controller 135 on the basis of this measurement may calculate the temperature of the heating chamber 110, the susceptor 190 or the article 10, respectively. The controller 135 may then cause a characteristic of the varying or alternating electrical current being applied to the inductor 150 of the at least one heating units 140a-140e, to be adjusted as necessary, in order to ensure that the temperature of the heating chamber 110, the susceptor 190 or the article 10, respectively, remains within a predetermined temperature range. The characteristic may be, for example, amplitude or frequency or duty cycle.

In some examples the secondary coil may be a coil of wire, or a track on a PCB.

In some examples the secondary coil may comprise any one or more of nickel, steel, iron and cobalt.

The device 100 may comprise a temperature sensor (not shown) for sensing a temperature of the heating chamber 110, the susceptor 190 or the article 10. The temperature sensor may be communicatively connected to the controller 135, so that the controller 135 is able to monitor the temperature of the heating chamber 110, the susceptor 190 or the article 10, respectively, on the basis of information output by the temperature sensor. In other examples, the temperature may be sensed and monitored by measuring electrical characteristics of the system, e.g., the change in current within the heating units 140a-140e. On the basis of one or more signals received from the temperature sensor, the controller 135 may cause a characteristic of the varying or alternating electrical current to be adjusted as necessary, in order to ensure that the temperature of the heating chamber 110, the susceptor 190 or the article 10, respectively, remains within a predetermined temperature range. The characteristic may be, for example, amplitude or frequency or duty cycle. Within the predetermined temperature range, in use the aerosolizable material 11 within the article 10 located in the heating chamber 110 is heated sufficiently to volatilize at least one component of the aerosolizable material 11 without combusting the aerosolizable material 11. Accordingly, the controller 135, and the device 100 as a whole, is arranged to heat the aerosolizable material 11 to volatilize the at least one component of the aerosolizable material 11 without combusting the aerosolizable material 11. The temperature range may be between about 50° C. and about 350° C., such as between about 100° C. and about 300° C., or between about 150° C. and about 280° C. In other examples, the temperature range may be other than one of these ranges. In some examples, the upper limit of the temperature range could be greater than 350° C. In some examples, the temperature sensor may be omitted.

Further discussion of the form of each of the heating units 140a-140e will be given below with reference to FIGS. 2 and 3. However, what is notable at this stage is that the size or extent of the varying magnetic fields as measured in the direction of the axis A-A is relatively small, so that the portions of the susceptor 190 that are penetrated by the varying magnetic fields in use are correspondingly small. Accordingly, it may be desirable for the susceptor 190 to have a thermal conductivity that is sufficient to increase the proportion of the susceptor 190 that is heated by thermal conduction as a result of the penetration by the varying magnetic fields, so as to correspondingly increase the proportion of the aerosolizable material 11 that is heated by operation of each of the heating units 140a-140e. It has been found that it is desirable to provide the susceptor 190 with a thermal conductivity of at least 10 W/m/K, optionally at least 50 W/m/K, and further optionally at least 100 W/m/K. In this example, the susceptor 190 is made of aluminum and has a thermal conductivity of over 200 W/m/K, such as between 200 and 250 W/m/K, for example approximately 205 W/m/K or 237 W/m/K. As noted above, each of the portions 11a-11e of the aerosolizable material 11 may, for example, have a length in the direction of the axis A-A of between 1 millimeter and 20 millimeters, such as between 2 millimeters and 10 millimeters, between 3 millimeters and 8 millimeters, or between 4 millimeters and 6 millimeters.

In this example, the heating apparatus 130 is configured to cause heating of the first portion 11a of the aerosolizable material 11 to a temperature sufficient to aerosolize a component of the first portion 11a of the aerosolizable material 11 before or more quickly than the heating of the second portion 11b of the aerosolizable material 11 during a heating session. More specifically, the controller 135 is configured to cause operation of the first and second heating units 140a, 140b to cause the heating of the first portion 11a of the aerosolizable material 11 before or more quickly than the heating of the second portion 11b of the aerosolizable material 11 during the heating session. Accordingly, during the heating session, the position at which heat energy is applied to the aerosolizable material 11 of the article 10 is initially relatively fluidly spaced from the outlet 120 and the user, and then moves towards the outlet 120. This provides the benefit that during a heating session aerosol is generated from successive “fresh” portions of the aerosolizable material 11, which can lead to a sensorially-satisfying experience for the user that may be more similar to that had when smoking a traditional combustible factory-made cigarette.

Moreover, in some examples, the controller 135 is configured to cause a cessation in the supply of power to the first heating unit 140a, during at least part of a period (or all of the period) for which the controller 135 is configured to cause operation of the second heating unit 140b. This provides the further benefit that aerosol generated in a given portion of the aerosolizable material 11 need not pass through another portion of the aerosolizable material 11 that has previously been heated, which could otherwise negatively impact the aerosol. For example, aerosol passing through previously-heated or spent aerosolizable material can result in the aerosol picking-up components that provide the aerosol with “off-notes”.

In some examples in which the heating apparatus 130 has more than two heating units, such as the example shown in FIG. 1, during the heating session the heating apparatus 130 may also be configured to cause heating of at least one further portion 11b-11e of the aerosolizable material 11 to a temperature sufficient to aerosolize a component of the further portion 11b-11e of the aerosolizable material 11 before or more quickly than the heating of a still further portion 11c-11e of the aerosolizable material 11 that is fluidly closer to the outlet 120. That is, the controller 135 may be configured to cause suitable operation of the heating units to cause the heating of the at least one further portion 11b-11e of the aerosolizable material 11 before or more quickly than the heating of the still further portion 11c-11e of the aerosolizable material 11. For example, in the device of FIG. 1, the heating apparatus 130 may be configured to cause: (i) heating of the second portion 11b of the aerosolizable material 11 to a temperature sufficient to aerosolize a component of the second portion 11b of the aerosolizable material 11 before or more quickly than the heating of the third portion 11c of the aerosolizable material 11; (ii) heating of the third portion 11c of the aerosolizable material 11 to a temperature sufficient to aerosolize a component of the third portion 11c of the aerosolizable material 11 before or more quickly than the heating of the fourth portion 11d of the aerosolizable material 11; and (iii) heating of the fourth portion 11d of the aerosolizable material 11 to a temperature sufficient to aerosolize a component of the fourth portion 11d of the aerosolizable material 11 before or more quickly than the heating of the fifth portion 11e of the aerosolizable material 11.

It will be understood that, for a given duration of heating session, the greater the number of heating units and associated portions of the aerosolizable material 11 there are, the greater the opportunity to generate aerosol from “fresh” or unspent portions of the aerosolizable material 11 extending along a given axial length. Alternatively, for a given duration of heating each portion of the aerosolizable material 11, the greater the number of heating units and associated portions of the aerosolizable material 11 there are, the longer the heating session may be. It should be appreciated that the duration for which an individual heating unit may be activated can be adjusted (e.g. shortened) to adjust (e.g. reduce) the overall heating session, and at the same time the power supplied to the heating element may be adjusted (e.g. increased) to reach the operational temperature more quickly. There may be a balance that is struck between the number of heating units (which may dictate the number of “fresh puffs”), the overall session length, and the achievable power supply (which may be dictated by the characteristics of the power source).

In some examples, the device 100 may comprise electromagnetic shielding (not shown) to at least partially surround any one or all of the controller 135, heating units 140a-140e and the heating units 140a-140e respective inductors 150. In other examples, the electromagnetic shielding may be disposed between the respective inductor 150 of a heating unit and the controller 135, such that the electromagnetic shielding partially surrounds the inductor 150 and/or the controller 135. In examples where there are more than one inductors 150, there may be more than one sections of electromagnetic shielding to at least partially surround any one or all of each of the inductors 150, the respective heating units 140a-140e for each of the inductors and the controller 135. In this same example, the sections of electromagnetic shielding may alternatively be disposed between each of the inductors 150 with their corresponding heating unit's 140a-140e and the controller 135.

Referring to FIG. 2, there is shown a flow diagram showing an example of a method of heating aerosolizable material during a heating session using an aerosol provision device. The aerosol provision device used in the method 200 comprises a heating zone for receiving at least a portion of an article comprising aerosolizable material, an outlet through which aerosol is deliverable from the heating zone to a user in use, and heating apparatus for causing heating of the article when the article is at least partially located within the heating zone to thereby generate the aerosol. The aerosol provision device may, for example, be that which is shown in FIG. 1 or any of the suitable variants thereof discussed herein.

The method 200 comprises the heating apparatus 130 causing, when the article 10 is at least partially located within the heating zone 110, heating 210 of a first portion 11a of the aerosolizable material 11 of the article 10 to a temperature sufficient to aerosolize a component of the first portion 11a of the aerosolizable material 11 before or more quickly than heating 220 of a second portion 11b of the aerosolizable material 11 of the article 10 to a temperature sufficient to aerosolize a component of the second portion 11b of the aerosolizable material 11, wherein the second portion 11b of the aerosolizable material 11 is fluidly located between the first portion 11a of the aerosolizable material 11 and the outlet 120.

It will be understood from the teaching herein that the method 200 could be suitably adapted to comprise the heating apparatus 130 also causing heating of at least one further portion 11b-11e of the aerosolizable material 11 to a temperature sufficient to aerosolize a component of the further portion 11b-11e of the aerosolizable material 11 before or more quickly than the heating of a still further portion 11c-11e of the aerosolizable material 11 that is fluidly closer to the outlet 120, as discussed above.

Referring to FIG. 3, there is shown a flow diagram showing another example of a method of heating aerosolizable material during a heating session using an aerosol provision device. The aerosol provision device used in the method 300 comprises a heating zone for receiving at least a portion of an article comprising aerosolizable material, an outlet through which aerosol is deliverable from the heating zone to a user in use, and heating apparatus for causing heating of the article when the article is at least partially located within the heating zone to thereby generate the aerosol. The heating apparatus comprises a first heating unit, a second heating unit, a third heating unit and a controller that is configured to cause operation of the first, second and third heating units. The aerosol provision device may, for example, be that which is shown in FIG. 1 or any of the suitable variants thereof discussed herein.

The method 300 comprises the controller 135 controlling the first, second and third heating units 140a, 140b, 140c independently of each other to cause, when the article 10 is at least partially located within the heating zone 110: the first heating unit 140a to heat 310 a first portion 11a of the aerosolizable material 11 of the article 10 to a temperature sufficient to aerosolize a component of the first portion 11a of the aerosolizable material 11 (e.g. before or more quickly than the second portion 11b); the second heating unit 140b to heat 320 a second portion 11b of the aerosolizable material 11 of the article 10 to a temperature sufficient to aerosolize a component of the second portion 11b of the aerosolizable material 11 (e.g. before or more quickly than the third portion 11c); and the third heating unit 140c to heat 330 a third portion 11c of the aerosolizable material 11 of the article 10 to a temperature sufficient to aerosolize a component of the third portion 11c of the aerosolizable material 11, wherein the second portion 11b of the aerosolizable material 11 is fluidly located between the first portion 11a of the aerosolizable material 11 and the outlet 120, and the third portion 11c of the aerosolizable material 11 is fluidly located between the second portion 11b of the aerosolizable material 11 and the outlet 120.

When the aerosol provision device used in the method 300 comprises sufficient heating units, it will be understood from the teaching herein that the method 300 could be suitably adapted to comprise the heating apparatus 130 also controlling fourth and fifth heating units 140d, 140e independently of each other to cause, when the article 10 is at least partially located within the heating zone 110: the fourth heating unit 140d to heat a fourth portion 11d of the aerosolizable material 11 of the article 10 to a temperature sufficient to aerosolize a component of the fourth portion 11d of the aerosolizable material 11; and the fifth heating unit 140e to heat a fifth portion 11e of the aerosolizable material 11 of the article 10 to a temperature sufficient to aerosolize a component of the fifth portion 11e of the aerosolizable material 11, wherein the fourth portion 11d of the aerosolizable material 11 is fluidly located between the third portion 11c of the aerosolizable material 11 and the outlet 120, and the fifth portion 11e of the aerosolizable material 11 is fluidly located between the fourth portion 11d of the aerosolizable material 11 and the outlet 120.

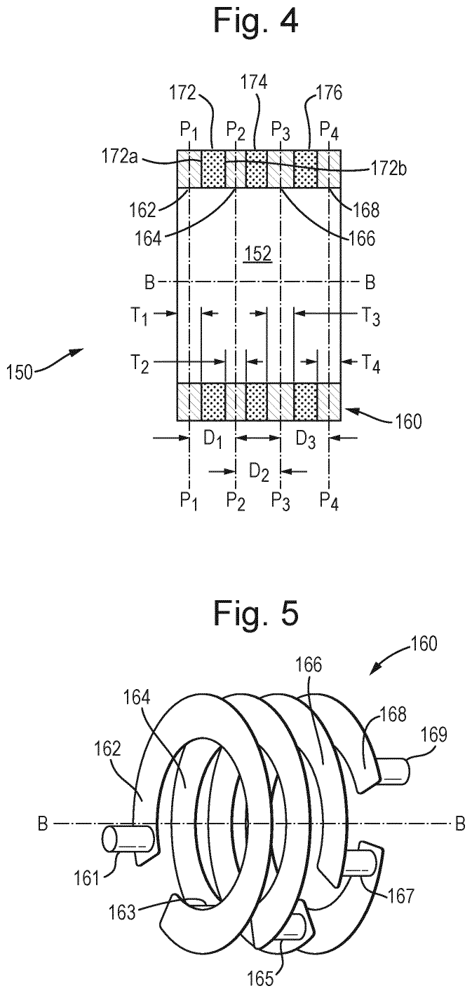

One of the heating units 140a-140e of the heating apparatus 130 will now be described in more detail with reference to FIGS. 4 and 5. These FIGURES respectively show a schematic cross-sectional side view of an inductor arrangement 150 of the heating unit and a schematic perspective view of an inductor 160 of the inductor arrangement 150.

The inductor arrangement 150 comprises an electrically-insulating support 172 and the inductor 160. The support 172 has opposite first and second sides 172a, 172b, and parts 162, 164 of the inductor 160 are on the respective first and second sides 172a, 172b of the support 172.

More specifically, the inductor 160 comprises an electrically-conductive element 160. The element 160 comprises an electrically-conductive non-spiral first portion 162 that is coincident with a first plane P₁, and an electrically-conductive non-spiral second portion 164 that is coincident with a second plane P₂ that is spaced from the first plane P₁. In this example, the second plane P₂ is parallel to the first plane P₁, but in other examples this need not be the case. For example, the second plane P₂ may be at an angle to the first plane P₁, such as an angle of no more than 20 degrees or no more than 10 degrees or no more than 5 degrees. The inductor 160 also comprises a first electrically-conductive connector 163 that electrically connects the first portion 162 to the second portion 164. The first portion 162 is on the first side 172a of the support 172, and the second portion 164 is on the second side 172b of the support 172. The electrically conductive connector 163 passes through the support 172 from the first side 172a to the second side 172b. The electrically conductive connector 163 may have the structure of plating (e.g. copper plating) on the surface of a through hole provided in the support 172.

The support 172 can be made of any suitable electrically-insulating material(s). In some examples, the support 172 comprises a matrix (such as an epoxy resin, optionally with added filler such as ceramics) and a reinforcement structure (such as a woven or non-woven material, such as glass fibers or paper).

The inductor 160 can be made of any suitable electrically-conductive material(s). In some examples, the inductor 160 is made of copper.

In some examples, the inductor arrangement 150 comprises, or is formed from, a PCB. In such examples, the support 172 is a non-electrically-conductive substrate of the PCB, which may be formed from materials such as FR-4 glass epoxy or cotton paper impregnated with phenolic resin, and the first and second portions 162, 164 of the inductor 160 are tracks on the substrate. This facilitates manufacture of the inductor arrangement 150, and also enables the portions 162, 164 of the element 160 to be thin and closely spaced, as discussed in more detail below.

In this example, the first portion 162 is a first partial annulus 162 and the second portion 164 is a second partial annulus 164. Moreover, in this example, each of the first and second portions 162, 164 follows only part of a respective circular path. Therefore, the first portion or first partial annulus 162 is a first circular arc, and the second portion or second partial annulus 164 is a second circular arc. In other examples, the first and second portions 162, 164 may follow a path that is other than circular, such as elliptical, polygonal or irregular. However, matching the shape of the first and second portions 162, 164 to the shape (or at least an aspect of the shape, such as outer perimeter) of respective adjacent portions of the susceptor 190 (whether provided in the device 100 or the article 10) helps lead to improved and more consistent magnetic coupling of the inductor 160 and the susceptor 190. Moreover, in examples in which the first and second portions 162, 164 are respective circular arcs, providing that the radii of the circular arcs are equal also can help lead to the generation of a more consistent magnetic field along the length of the inductor 160, and thus more consistent heating of the susceptor 190.

The inductor arrangement 150 has a through-hole 152 that is radially-inward of, and coaxial with, the first and second portions 162, 164 or partial annuli. In the assembled device 100, the susceptor 190 and the heating zone 110 extend through the through-hole 152, so that the portions 162, 164 of the element 160 together at least partially encircle the susceptor 190 and the heating zone 110. In examples in which the susceptor 190 is replaced by plural susceptors, each of the plural susceptors may be located so as to extend through the through-holes 152 of one or more inductor arrangements 150 of the respective heating units 140a.-140e. In some examples, the or each susceptor does not extend through the through-holes 152, but rather is adjacent (e.g. axially) the associated element 160.

In examples in which the heating apparatus 130 is free from a susceptor, as discussed above, the heating zone 110 may still nevertheless extend through some or all of the through-holes 152 of the inductor arrangements 150 of the respective heating units 140a.-140e. In some such examples, the article 10 comprises one or more susceptors, such as a metallic foil (e.g. aluminum foil) wrapped around or otherwise encircling the aerosolizable material 11 and/or a susceptor, such as in the form of a pad, at one end of the article 10 axially adjacent the aerosolizable material 11 of the article 10. In some examples, the susceptor of an article 10 comprising liquid or gel or otherwise flowable aerosolizable material may comprise a susceptor (e.g. metallic) in, or coated on, a (e.g. ceramic) wick. In some examples, portions 11a-11e of the aerosolizable material 11 have the same respective forms or characteristics, or have different respective forms or characteristics, such as different tobacco blends and/or different applied or inherent flavors. In some such examples, the article 10 may comprise plural susceptors, each of which is arranged and heatable to heat a respective one of the portions 11a-11e of the aerosolizable material 11. In some examples, the portions 11a-11e of the aerosolizable material 11 are isolated from each other. In other examples, there may be plural heating zones, each of which is located between a pair of the inductor arrangements 150. Some or all of the plural heating zones may not extend through the through-holes 152. The plural heating zones may be for receiving respective articles 10 comprising aerosolizable material 11. The aerosolizable material 11 of the respective articles 10 may be of the same or different respective forms or characteristics. In some examples, the through-holes 152 may be omitted.

As may best be understood from further consideration of FIG. 5, when viewed in a direction orthogonal to the first plane P₁, and thus in the direction of an axis B-B of the inductor 160, the first and second portions 162, 164 extend in opposite senses of rotation from the first electrically-conductive connector 163. For example, were one to view the inductor 160 of FIG. 5 in the direction of the axis B-B from left to right as FIG. 5 is drawn, then the first portion 162 of the inductor 160 would extend in an anticlockwise direction from the connector 163, whereas the second portion 164 of the inductor 160 would extend in a clockwise direction from the connector 163.

Moreover, in this example, when viewed in the direction orthogonal to the first plane P₁, the first portion 162 or first partial annulus overlaps, albeit only partially, the second portion 164 or second partial annulus. In this example, the first and second portions 162, 164 together define about 1.75 turns about the axis B-B that is orthogonal to the first and second planes P₁, P₂. In other examples, the number of turns may be other than 1.75, such as another number that is at least 0.9. For example, the number of turns may be between 0.9 and 1.5, or between 1 and 1.25. In other examples, the number of turns may be less than 0.9, although decreasing the number of turns per support 172 may lead to an increase in the axial length of the inductor assembly 150.

Furthermore, when viewed in the direction orthogonal to the first plane P₁, the first portion 162 or first partial annulus, as well as the second portion 164 or second partial annulus, at least partially overlaps the first electrically-conductive connector 163. This is facilitated by the inductor arrangement 150 comprising, or being formed from, a PCB (or more generally, a planar substrate layer). In particular, in such examples, the first electrically-conductive connector 163 takes the form of a “via” that extends through the support 172. Even in examples in which the inductor arrangement 150 is not formed from a PCB, the connector 163 still may extend through the support 172. This overlapped arrangement enables the inductor 160 to occupy a relatively small footprint, when viewed in the direction orthogonal to the first plane P₁, as compared to a comparative example in which the first and second portions 162, 164 are connected by a connector 163 that is spaced radially outwards of the first and second portions 162, 164. Furthermore, this overlapped arrangement enables the width of the through-hole 152 to be increased, as compared to a comparative example in which the first and second portions 162, 164 are connected by a connector 163 that is spaced radially inwards of the first and second portions 162, 164. Nevertheless, in some examples, the connector 163 may be radially-inward or radially-outward of the first and second portions 162, 164. This may be effected by the connector 163 being formed by a “through via” that extends through the support 172. Through vias tend to be cheaper to form than blind vias, as they can be formed after the PCB has been manufactured.

It will be noted that, in this example, the inductor arrangement 150 comprises two further supports 174, 176, and the element 160 comprises two further electrically-conductive non-spiral portions 166, 168 that are coincident with two respective spaced-apart planes P₃, P₄ that are parallel to the first plane P₁. In other examples, one or each of the spaced-apart planes P₃, P₄ may be at an angle to the first plane P₁, such as an angle of no more than 20 degrees or no more than 10 degrees or no more than 5 degrees. The second and third electrically-conductive non-spiral portions 164, 166 are on opposite sides of the second support 174, and are electrically connected by a second electrically-conductive connector 165. The third and fourth electrically-conductive non-spiral portions 166, 168 are on opposite sides of the third support 176, and are electrically connected by a third electrically-conductive connector 167. The second and third electrically-conductive connectors 165, 167 are rotationally offset from the first electrically-conductive connector 163. In arrangements in which the supports 172, 174 and 176 are formed as a PCB, the connectors 163 and 167 may be formed as “blind vias”, while connector 165 may be formed as a “buried via”.

In this example, the first, second, third and fourth portions or partial annuli 162, 164, 166, 168 together define a total of about 3.6 turns about the axis B-B that is orthogonal to the first and second planes P₁, P₂. In other examples, the total number of turns may be other than 3.6, such as another number that is between 1 and 10. For example, the total number of turns may be between 1 and 8, or between 1 and 4. Having a relatively small total number of turns is thought to increase the voltage that will be available in the susceptor 190 (whether provided in the device 100 or the article 10) for forcing electrical current along or around the susceptor 190.

It will be noted that the inductor 160 also comprises first and second terminals 161, 169 at opposite ends of the inductor 160. These terminals are for the passage of electrical current through the inductor 160 in use.

In this example, each of the first, second and third supports 172, 174, 176 has a thickness of about 0.85 millimeters. In some examples, one or more of the supports 172, 174, 176 may have a thickness other than 0.85 millimeters, such as another thickness lying in the range of 0.2 millimeters to 2 millimeters. For example, each of the thicknesses may be between 0.5 millimeters and 1 millimeter, or between 0.75 millimeterss and 0.95 millimeters. In some examples, the thicknesses of the respective supports 172, 174, 176 are equal to each other, or substantially equal to each other. In other examples, one or more of the supports 172, 174, 176 may have a thickness that differs from a thickness of one or more of the other supports 172, 174, 176.

In this example, each of the portions 162, 164, 166, 168 of the inductor 160 has a thickness, measured in a direction orthogonal to the first plane P₁, of about 142 micrometers. In some examples, one or more of the portions 162, 164, 166, 168 of the inductor 160 may have a thickness other than 142 micrometers, such as another thickness lying in the range of 10 micrometers to 200 micrometers. For example, each of the thicknesses may be between 25 micrometers and 175 micrometers, or between 100 micrometers and 150 micrometers.

In examples in which the inductor arrangement 150 is made from a PCB, the thickness of the material of the inductor 160 may be determined by “plating-up” the material on the substrate, prior to construction of the PCB. Some standard circuit boards have a 1 oz layer of electrically-conductive material, such as copper, on the substrate. A 1 oz layer has a thickness of about 38 micrometers. By plating-up to a 4 oz layer, the thickness is increased to about 142 micrometers.

Increasing the thickness makes the structure of the inductor arrangement more robust and reduces system losses due to a commensurate reduction in ohmic losses. Increasing the volume of material of the inductor 160 will increase the heat capacity of the inductor 160, reducing the temperature gain for a given input of heat. This may be beneficial, as it can be used to help ensure that the temperature of the inductor 160 itself in use does not get so high as to cause damage to the structure of the inductor arrangement 150. In some examples, the thicknesses of the respective portions 162, 164, 166, 168 of the inductor 160 are equal to each other, or substantially equal to each other. This can lead to a more consistent heating effect being produced by the different portions of the inductor 160. In other examples, one or more of the portions 162, 164, 166, 168 of the inductor 160 may have a thickness that differs from a thickness of one or more of the other portions 162, 164, 166, 168 of the inductor 160. This may be intentional in some examples, so as to provide an increased heating effect produced by certain portion(s) of the inductor 160 as compared to the heating effect produced by other portion(s) of the inductor 160.

In this example, each of the planes P₁-P₄ is a flat plane, or a substantially flat plane. However, this need not be the case in other examples.

The first and second planes P₁, P₂ are spaced apart by a distance D₁ in the direction of an axis B-B of the inductor 160, as shown in FIG. 5. In this example, the distance D₁ between the first and second planes P₁, P₂ measured in a direction orthogonal to the first and second planes P₁, P₂ is less than 2 millimeters, such as less than 1 millimeter. In other examples, the distance D₁ may be between 1 millimeter and 2 millimeters, or more than 2 millimeters, for example.

The combination of the first electrically-conductive connector 163 and the first and second portions 162, 164 of the electrically-conductive element 160 can be considered to be, or to approximate, a helical coil. Indeed, the full inductor 160 can be considered to be, or to approximate, a helical coil.

Given the distances D₁, D₂, D₃ between adjacent pairs of the planes P₁, P₂, P₃, P₄, the coil of this example can be considered to have a pitch of less than 2 millimeters, such as less than 1 millimeter. In other examples, the pitch may be between 1 millimeter and 2 millimeters, or more than 2 millimeters, for example. Optionally, a distance between each adjacent pair of the portions 162, 164, 166, 168 of the element 160 is equal to, or differs by less than 10% from, a distance between each other adjacent pair of the portions 162, 164, 166, 168 of the element 160. This can lead to the generation of a more consistent magnetic field along the length of the inductor 160, and thus more consistent heating of the susceptor 190.

The smaller the pitch, the greater the ratio of magnetic field strength to mass of susceptor 190 (whether provided in the device 100 or the article 10) to which the energy is being applied. However, this needs to be balanced against the negative effects of the “proximity effect”. In particular, as the pitch is reduced, losses due to the proximity effect increase. Therefore, careful pitch selection is required to reduce the losses in the inductor 160 while increasing the energy available for heating the susceptor 190. It has been found that, in some examples, when the inductors 160 and the controller 135 are suitably configured, they cause the generation of a magnetic field having a magnetic flux density of at least 0.01 Tesla. In some examples, the magnetic flux density is at least 0.1 Tesla.

Relatively small pitches are enabled through the manufacture of the inductor arrangement 150 from a PCB. Given the present teaching, the skilled person would be able to conceive of other ways of manufacturing induction coils with a similarly small pitch. However, manufacture of the inductor arrangement 150 from a PCB is likely also to be cheaper than some other ways of manufacturing induction coils, such as by winding LITZ (RTM) wire.

While the inductor arrangement 150 of the example shown in the Figures has three supports 172, 174, 176 and an inductor 160 comprising four portions 162, 164, 166, 168, this need not be the case in other examples. In some examples, the inductor 160 may have more or fewer than four portions, such as only three portions 162, 164, 166 or only two portions 162, 164. In some examples, the inductor arrangement 150 may have more or fewer than three supports, such as only two supports 172, 174 or only one support 172. Indeed, in some examples, the number of supports in the inductor arrangement 150 may be only one, and the number of portions of the inductor 160 may be only two, and those two portions 162, 164 of the inductor 160 would be on opposite sides of the single support 172. It will be understood that the number of electrically-conductive connectors 163, 165, 167 would have to be correspondingly adjusted depending on the number of two portions 162, 164, 166, 168 present in the inductor 160. In some examples, the inductor 160 may be provided without any supports between the portions 162, 164, 166, 168 of the inductor 160. In such examples, it is desirable for the inductor 160 to be of sufficient strength to be self-supporting.

The inductor arrangements 150 of the respective heating units 140a-140e, or the inductors 160 thereof, may be provided in an inductor assembly or a magnetic field generator 130 for inclusion in an aerosol provision device, such as the device 100 of FIG. 1 or any of the variants thereof discussed herein. The inductors 160 of the inductor assembly, magnetic field generator 130 or device 100 may be spaced apart by a distance selected so as to enable heating of a majority or otherwise desired amount of the aerosolizable material 11, while avoiding or reducing interference between the inductors 160. As noted herein, the relatively small pitch of the inductors has been found to result in the generation of a varying magnetic field that is relatively concentrated, so that others of the inductors 160 can be placed relatively closely without suffering too much from interference. Adjacent inductors 160 may be spaced apart by a distance of between 5 millimeters and 50 millimeters, such as a distance of between 10 millimeters and 40 millimeters or a distance of between 15 millimeters and 30 millimeters. Other distances may be employed in other examples.

Once all, substantially all, or many of the volatilizable component(s) of the aerosolizable material 11 in the article 10 has/have been spent, the user may remove the article 10 from the heating chamber 110 of the device 100 and dispose of the article 10.

In some examples, the article 10 is sold, supplied or otherwise provided separately from the device 100 with which the article 10 is usable. However, in some examples, the device 100 and one or more of the articles 10 may be provided together as a system, such as a kit or an assembly, possibly with additional components, such as cleaning utensils.

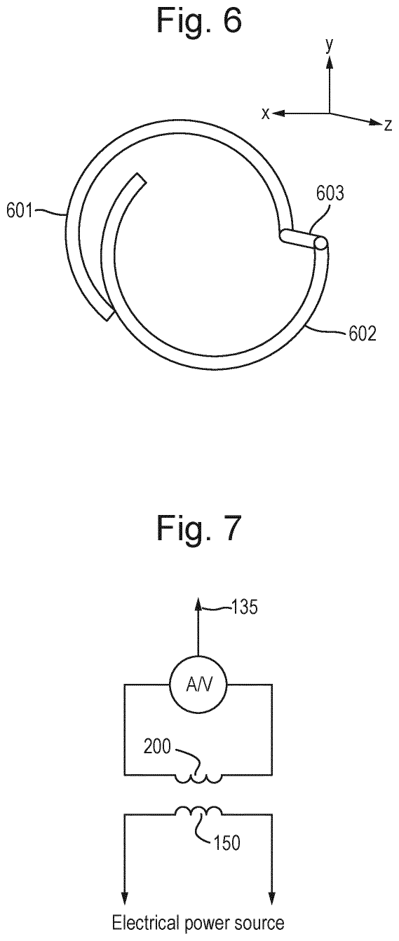

FIG. 6 illustrates an embodiment wherein an inductor coil as shown may be located in close proximity with a secondary (or sense) coil (not shown). The inductor may form part of an aerosol provision device.

The inductor comprises an electrically-conductive element wherein the element comprises an electrically-conductive non-spiral first portion 601 coincident with a first plane, an electrically-conductive non-spiral second portion 602 coincident with a second plane that is spaced from the first plane, and an electrically-conductive connector 603 that electrically connects the first portion to the second portion. The second plane may be parallel to the first plane.

The first portion 601 may comprise a first partial annulus and the second portion 602 may comprise a second partial annulus.

According to an embodiment an inductor for use in an aerosol provision device is disclosed wherein the inductor comprises an electrically-conductive element; wherein the element comprises an electrically-conductive first partial annulus 601 coincident with a first plane, an electrically-conductive second partial annulus 602 coincident with a second plane that is spaced from the first plane, and an electrically-conductive connector 603 that electrically connects the first partial annulus 601 to the second partial annulus 602. The second plane may be parallel to the first plane.

The first portion or first partial annulus 601 may comprise a first circular arc, and the second portion or second partial annulus 602 may comprise a second circular arc.

When viewed in a direction orthogonal to the first plane, the first and second portions or partial annuli 601,602 may be considered as extending in opposite senses of rotation from the electrically-conductive connector 603.

When viewed in a direction orthogonal to the first plane, the first portion or first partial annulus 601 may be considered as overlapping, only partially, the second portion or second partial annulus 602.

When viewed in a direction orthogonal to the first plane, the first portion or first partial annulus 601 may at least partially overlap the electrically-conductive connector 603. The first and second planes may be flat planes. A distance between the first and second planes measured in a direction orthogonal to the first and second planes may be less than 2 millimeters. In an exemplary embodiment, the distance between the first and second planes may be less than 1 millimeter. The first and second portions or partial annuli 601,602 may together define at least 0.9 turns about an axis that is orthogonal to the first and second planes.

The element may comprise further electrically-conductive non-spiral portions or electrically-conductive partial annuli that are coincident with respective spaced-apart planes. The spaced-apart planes may be parallel to the first plane.

According to an embodiment, the total number of turns, about an axis, defined by all of the electrically-conductive non-spiral portions or partial annuli of the element together may be between 1 and 10. In an exemplary embodiment, the total number of turns may be between 1 and 8. In an exemplary embodiment, the total number of turns may be between 1 and 4.

A distance between each adjacent pair of the portions or partial annuli of the element may be equal to, or differ by less than 10% from, a distance between each other adjacent pair of the portions or partial annuli of the element.

Each of the first and second portions or partial annuli may have a thickness, measured in a direction orthogonal to the first plane, of between 10 micrometers and 200 micrometers. In an exemplary embodiment, the thickness may be between 25 micrometers and 175 micrometers. In an exemplary embodiment, the thickness is between 100 micrometers and 150 micrometers.

An inductor for use in an aerosol provision device is disclosed. The inductor may comprise a coil having a pitch of less than 2 millimeters. The pitch may be less than 1 millimeter. An inductor arrangement for use in an aerosol provision device is disclosed. The inductor arrangement may comprises an electrically-insulating support having opposite first and second sides. The inductor arrangement may comprise an inductor as disclosed above wherein the first portion or first partial annulus is on the first side of the support, and the second portion or second partial annulus is on the second side of the support.

The inductor arrangement may have a through-hole that is radially-inward of, and coaxial with, the first and second portions or partial annuli. The electrically-conductive connector of the inductor may extend through the support. The support may have a thickness of between 0.2 millimeters and 2 millimeters. In an exemplary embodiment, the support may have a thickness of between 0.5 millimeters and 1 millimeter. In an exemplary embodiment, the support has a thickness of between 0.75 millimeters and 0.95 millimeters.

The inductor arrangement may comprise a printed circuit board, wherein the support is a non-electrically-conductive substrate of the printed circuit board and the first and second portions or partial annuli are tracks on the substrate.

An embodiment is disclosed comprising an inductor assembly for use in an aerosol provision device. The inductor assembly may comprise plural inductors or may comprise plural inductor arrangements. According to another embodiment a magnetic field generator for use in an aerosol provision device is disclosed. The magnetic field generator may comprise one or more inductors or one or more inductor arrangements as disclosed above.

The magnetic field generator may comprise one or more inductors and an apparatus that is operable to pass a varying electrical current through the one or more inductors, wherein the one or more inductors and the apparatus are configured to cause the generation of a magnetic field having a magnetic flux density of at least 0.01 Tesla. In an exemplary embodiment, the magnetic flux density is at least 0.1 Tesla.

The magnetic field generator may comprise one or more inductor arrangements and the one or more inductors of the magnetic field generator may be of the respective one or more inductor arrangements.

An aerosol provision device is disclosed comprising a heating zone for receiving at least a portion of an article comprising aerosolizable material and a magnetic field generator, wherein the magnetic field generator is configured to be operable to generate a varying magnetic field for use in heating at least part of the aerosolizable material of the article when the article is in the heating zone.

In an exemplary embodiment, the, or each, inductor of the magnetic field generator at least partially encircles the heating zone.

In an exemplary embodiment, the aerosol provision device comprises a susceptor that is heatable by penetration with the varying magnetic field to thereby cause heating of the heating zone.

In an exemplary embodiment, the magnetic field generator is configured to be operable to generate plural respective varying magnetic fields independently of each other, for use in heating respective parts of the aerosolizable material of the article independently of each other.

An aerosol provision system is disclosed comprising an aerosol provision device and an article comprising aerosolizable material, wherein the article comprising aerosolizable material is at least partially insertable into the heating zone.

An inductor for use in an aerosol provision device is disclosed. The inductor may comprise an electrically-conductive element and a secondary coil; wherein the element comprises an electrically-conductive non-spiral first portion coincident with a first plane, an electrically-conductive non-spiral second portion coincident with a second plane that is spaced from the first plane, and an electrically-conductive connector that electrically connects the first portion to the second portion; and wherein the electrically-conductive element is configured such that when a varying electrical current is applied to the electrically-conductive element, a corresponding varying electrical current is induced in the secondary coil.

An inductor for use in an aerosol provision device is disclosed. The inductor may comprise an electrically-conductive element and a secondary coil; wherein the element comprises an electrically-conductive first partial annulus coincident with a first plane, an electrically-conductive second partial annulus coincident with a second plane that is spaced from the first plane, and an electrically-conductive connector that electrically connects the first partial annulus to the second partial annulus; and wherein the electrically-conductive element is configured such that when a varying electrical current is applied to the electrically-conductive element, a corresponding varying electrical current is induced in the secondary coil.

A magnetic field generator for use in an aerosol provision device is disclosed. The magnetic field generator may comprise one or more inductors, one or more coils and an apparatus that is operable to pass a varying electrical current through the one or more inductors; wherein when the apparatus passes a varying electrical current through the one or more inductors, a corresponding varying electrical current is induced in the one or more coils; and wherein the one or more inductors and the apparatus are configured to cause the generation of a magnetic field having a magnetic flux density of at least 0.01 Tesla.

According to an embodiment there is disclosed an inductor for use in an aerosol provision device, the inductor comprising: an electrically-conductive element and electromagnetic shielding; wherein the element comprises an electrically-conductive non-spiral first portion coincident with a first plane, an electrically-conductive non-spiral second portion coincident with a second plane that is spaced from the first plane, and an electrically-conductive connector that electrically connects the first portion to the second portion; and wherein the electromagnetic shielding is arranged to at least partially surround at least one of the electrically-conductive non-spiral first portion coincident with the first plane, the electrically-conductive non-spiral second portion with the second plane and the electrically-conductive connector.

According to an embodiment there is disclosed an inductor for use in an aerosol provision device.

FIG. 7 shows an embodiment wherein a single sense coil 200 is located in close proximity to two inductor coils 150.

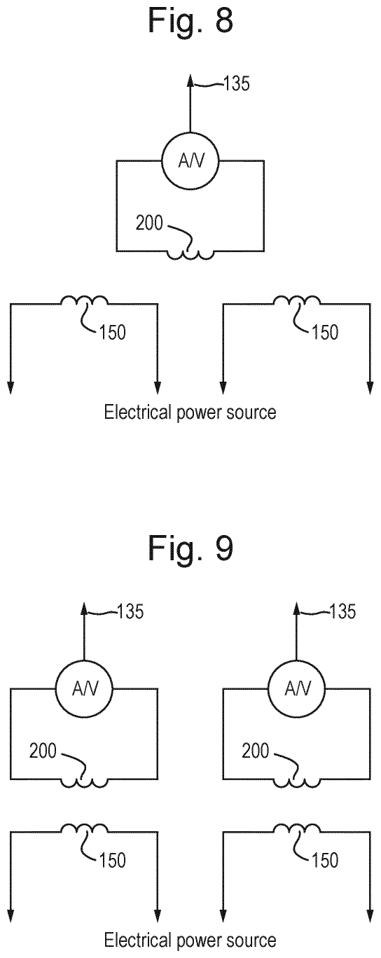

FIG. 8 shows a further embodiment wherein two inductor coils 150 are provided and a single sense coil 200 is provided.

FIG. 9 shows an embodiment wherein two inductor coils 150 are provided and wherein each inductor coil 150 is located in proximity to a different sense coil 200.

The inductor may comprise an electrically-conductive element and electromagnetic shielding, wherein the element comprises an electrically-conductive first partial annulus coincident with a first plane, an electrically-conductive second partial annulus coincident with a second plane that is spaced from the first plane, and an electrically-conductive connector that electrically connects the first partial annulus to the second partial annulus; and wherein the electromagnetic shielding is arranged to at least partially surround at least one of the electrically-conductive first partial annulus coincident with the first plane, the electrically-conductive second partial annulus coincident with the second plane and the electrically-conductive connector.

According to another embodiment there is disclosed a magnetic field generator for use in an aerosol provision device, the magnetic field generator comprising one or more inductors, an apparatus that is operable to pass a varying electrical current through the one or more inductors, and electromagnetic shielding; wherein the electromagnetic shielding is arranged between the one or more inductors and the apparatus, wherein the electromagnetic shielding is further arranged to at least partially surround the one or more inductors and/or the apparatus; and wherein the one or more inductors and the apparatus are configured to cause the generation of a magnetic field having a magnetic flux density of at least 0.01 Tesla.

The aerosol generating device, aerosol generating system and the inductor coil according to various embodiments find particular utility when generating aerosol from a substantially flat consumable. The substantially flat consumable may be provided in either an array or a circular format. Other arrangements are also contemplated.

In some embodiments e.g. wherein the substantially flat consumable is provided in the form of an array, multiple heating regions may be provided. For example, according to an embodiment one heating region may be provided per portion, pixel or portion of the consumable.

In other embodiments, the substantially flat consumable may be rotated such that a segment of the consumable is heated by a similar shaped heater. According to this embodiment a single heating region may be provided.

In particular, the inductor coil according to various embodiments may be provided as part of a non-combustible aerosol provision device which is arranged to heat-not-burn a consumable as part of a non-combustible aerosol provision system. In particular, the consumable may comprise a plurality of discrete portions of aerosol-generating material.

The consumable may comprise a support on which the aerosol-generating material is provided. The support functions as a support on which the aerosol-generating material forms, easing manufacture. The support may provide tensile strength to the aerosol-generating material, easing handling. In some cases, the plurality of discrete portions of aerosol-generating material are deposited on such a support. In some cases, the plurality of discrete portions of amorphous material is deposited on such a support. In some cases, the discrete portions of aerosol-generating material are deposited on such a support such that each discrete portion may be heated and aerosolized separately.

Suitably, the discrete portions of aerosol-generating material are provided on the support such that each discrete portion may be heated and aerosolized separately. It has been found that a consumable having such a conformation allows a consistent aerosol to be delivered to the user with each puff.

In some cases, the support may be formed from materials selected from metal foil, paper, carbon paper, greaseproof paper, ceramic, carbon allotropes such as graphite and graphene, plastic, cardboard, wood or combinations thereof. In some cases, the support may comprise or consist of a tobacco material, such as a sheet of reconstituted tobacco. In some cases, the support may be formed from materials selected from metal foil, paper, cardboard, wood or combinations thereof. In some cases, the support itself be a laminate structure comprising layers of materials selected from the preceding lists. In some cases, the support may also function as a flavorant carrier. For example, the support may be impregnated with a flavorant or with tobacco extract. In some cases, the support may be non-magnetic. In some cases, the support may be magnetic. This functionality may be used to fasten the support to the assembly in use, or may be used to generate particular amorphous solid shapes. In some cases, the aerosol-generating material may comprise one or more magnets which can be used to fasten the material to an induction heater in use.

In some cases, the support may be substantially or wholly impermeable to gas and/or aerosol. This prevents aerosol or gas passage through the support layer, thereby controlling the flow and ensuring it is delivered to the user. This can also be used to prevent condensation or other deposition of the gas/aerosol in use on, for example, the surface of a heater provided in an aerosol generating assembly. Thus, consumption efficiency and hygiene can be improved in some cases.

In some cases, the surface of the support that abuts the aerosol-generating material may be porous. For example, in one case, the support comprises paper. It has been found that a porous support such as paper is particularly suitable for the present disclosure; the porous (e.g. paper) layer abuts the aerosol-generating material and forms a strong bond. The aerosol-generating material is formed by drying a gel and, without being limited by theory, it is thought that the slurry from which the gel is formed partially impregnates the porous support (e.g. paper) so that when the gel sets and forms cross-links, the support is partially bound into the gel. This provides a strong binding between the gel and the support (and between the dried gel and the support).

In one particular case, the support may be a paper-backed foil; the paper layer abuts the aerosol-generating material and the properties discussed in the previous paragraphs are afforded by this abutment. The foil backing is substantially impermeable, providing control of the aerosol flow path. A metal foil backing may also serve to conduct heat to the aerosol-generating material.

In another case, the foil layer of the paper-backed foil abuts the aerosol-generating material. The foil is substantially impermeable, thereby preventing water provided in the aerosol-generating material to be absorbed into the paper which could weaken its structural integrity.

In some cases, the support is formed from or comprises metal foil, such as aluminum foil. A metallic support may allow for better conduction of thermal energy to the amorphous solid. Additionally, or alternatively, a metal foil may function as a susceptor in an induction heating system. In particular embodiments, the support comprises a metal foil layer and a support layer, such as cardboard. In these embodiments, the metal foil layer may have a thickness of less than 20 μm, such as from about 1 μm to about 10 μm, suitably about 5 μm.

In some cases, the support may have a thickness of between about 0.010 mm and about 2.0 mm, suitably from about 0.015 mm, 0.02 mm, 0.05 mm or 0.1 mm to about 1.5 mm, 1.0 mm, or 0.5 mm.

It is contemplated that the sense coil may be provided anywhere in the stack up in a PCB. For example, according to an embodiment the sense coil may be provided on the outer surface of the PCB for ease of connection. Electrically, the sense coil may be considered as a transformer acting only as a receiver coupling in from the primary warming coil.

It will be apparent that the susceptor is another transformer again acting as a receiver, but its load will be significantly lower and draws the most current by a significant margin. It will be understood that the sense coil load is very small.

This embodiment may be optimized for PCB since movement is an issue, but it will be understood that the disclosure is not limited to a PCB.

In order to address various issues and advance the art, the entirety of this disclosure shows by way of illustration and example various embodiments in which the claimed invention may be practiced and which provide for superior inductors, superior inductor arrangements, superior inductor assemblies, superior magnetic field generators, superior aerosol provision devices, and superior aerosol provision systems. The advantages and features of the disclosure are of a representative sample of embodiments only, and are not exhaustive and/or exclusive. They are presented only to assist in understanding and teach the claimed and otherwise disclosed features. It is to be understood that advantages, embodiments, examples, functions, features, structures and/or other aspects of the disclosure are not to be considered limitations on the disclosure as defined by the claims or limitations on equivalents to the claims, and that other embodiments may be utilized and modifications may be made without departing from the scope and/or spirit of the disclosure. Various embodiments may suitably comprise, consist of, or consist in essence of, various combinations of the disclosed elements, components, features, parts, steps, means, etc. The disclosure may include other inventions not presently claimed, but which may be claimed in future.

1. An inductor for use in an aerosol provision device, the inductor comprising:
an electrically-conductive element; and
a secondary coil;
wherein the element comprises an electrically-conductive non-spiral first portion coincident with a first plane, an electrically-conductive non-spiral second portion coincident with a second plane that is spaced from the first plane, and an electrically-conductive connector that electrically connects the first portion to the second portion; and
wherein the electrically-conductive element is configured such that when a varying electrical current is applied to the electrically-conductive element, a corresponding varying electrical current is induced in the secondary coil.

2. An inductor for use in an aerosol provision device, the inductor comprising:
an electrically-conductive element; and
a secondary coil;
wherein the element comprises an electrically-conductive first partial annulus coincident with a first plane, an electrically-conductive second partial annulus coincident with a second plane that is spaced from the first plane, and an electrically-conductive connector that electrically connects the first partial annulus to the second partial annulus; and
wherein the electrically-conductive element is configured such that when a varying electrical current is applied to the electrically-conductive element, a corresponding varying electrical current is induced in the secondary coil.

3. An inductor for use in an aerosol provision device, the inductor comprising:
an electrically-conductive element; and
electromagnetic shielding;
wherein the electrically-conductive element comprises an electrically-conductive non-spiral first portion coincident with a first plane, an electrically-conductive non-spiral second portion coincident with a second plane that is spaced from the first plane, and an electrically-conductive connector that electrically connects the first portion to the second portion; and
wherein the electromagnetic shielding is arranged to at least partially surround at least one of: (i) the electrically-conductive non-spiral first portion coincident with the first plane; (ii) the electrically-conductive non-spiral second portion with the second plane; and (iii) the electrically-conductive connector.

4. An inductor for use in an aerosol provision device, the inductor comprising:
an electrically-conductive element; and
electromagnetic shielding;
wherein the electrically-conductive element comprises an electrically-conductive first partial annulus coincident with a first plane, an electrically-conductive second partial annulus coincident with a second plane that is spaced from the first plane, and an electrically-conductive connector that electrically connects the first partial annulus to the second partial annulus; and
wherein the electromagnetic shielding is arranged to at least partially surround at least one of: (i) the electrically-conductive non-spiral first portion coincident with the first plane; (ii) the electrically-conductive non-spiral second portion with the second plane; and (iii) the electrically-conductive connector.

5. An inductor for use in an aerosol provision device, the inductor comprising: an electrically-conductive element;
wherein the element comprises an electrically-conductive non-spiral first portion coincident with a first plane, an electrically-conductive non-spiral second portion coincident with a second plane that is spaced from the first plane, and an electrically-conductive connector that electrically connects the first portion to the second portion.

6. An inductor as claimed in claim 5, wherein the first portion is a first partial annulus and the second portion is a second partial annulus.

7. An inductor for use in an aerosol provision device, the inductor comprising:
an electrically-conductive element, wherein the element comprises an electrically-conductive first partial annulus coincident with a first plane, an electrically-conductive second partial annulus coincident with a second plane that is spaced from the first plane, and an electrically-conductive connector that electrically connects the first partial annulus to the second partial annulus.

8. An inductor as claimed in any preceding claim, wherein the first portion or first partial annulus is a first circular arc, and the second portion or second partial annulus is a second circular arc.

9. An inductor as claimed in any preceding claim, wherein, when viewed in a direction orthogonal to the first plane, the first and second portions or partial annuli extend in opposite senses of rotation from the electrically-conductive connector.

10. An inductor as claimed in any preceding claim, wherein, when viewed in a direction orthogonal to the first plane, the first portion or first partial annulus overlaps, only partially, the second portion or second partial annulus.

11. An inductor as claimed in any preceding claim, wherein, when viewed in a direction orthogonal to the first plane, the first portion or first partial annulus at least partially overlaps the electrically-conductive connector.

12. An inductor as claimed in any preceding claim, wherein the first and second planes are flat planes.

13. An inductor as claimed in any preceding claim, wherein a distance between the first and second planes measured in a direction orthogonal to the first and second planes is less than 2 millimetres.

14. An inductor as claimed in any preceding claim, wherein the first and second portions or partial annuli together define at least 0.9 turns about an axis that is orthogonal to the first and second planes.

15. An inductor as claimed in any preceding claim, wherein the element comprises further electrically-conductive non-spiral portions or electrically-conductive partial annuli that are coincident with respective spaced-apart planes.

16. An inductor as claimed in claim 15, wherein a total number of turns, about an axis, defined by all of the electrically-conductive non-spiral portions or partial annuli of the element together is between one and ten.

17. An inductor as claimed in claim 15 or 16, wherein a distance between each adjacent pair of the portions or partial annuli of the element is equal to, or differs by less than 10% from, a distance between each other adjacent pair of the portions or partial annuli of the element.

18. An inductor as claimed in any preceding claim, wherein each of the first and second portions or partial annuli has a thickness, measured in a direction orthogonal to the first plane, of between 10 micrometres and 200 micrometres.

19. An inductor for use in an aerosol provision device, the inductor comprising a coil having a pitch of less than 2 millimetres.

20. An inductor arrangement for use in an aerosol provision device, the inductor arrangement comprising:
an electrically-insulating support having opposite first and second sides; and
an inductor as claimed in any of claims 1-19, wherein the first portion or first partial annulus is on the first side of the support and the second portion or second partial annulus is on the second side of the support.

21. An inductor arrangement according to claim 20, wherein the inductor arrangement has a through-hole that is radially-inward of, and coaxial with, the first and second portions or partial annuli.

22. An inductor arrangement according to claim 20 or 21, wherein the electrically-conductive connector of the inductor extends through the support.

23. An inductor arrangement according to any one of claim 20, 21 or 22, wherein the support has a thickness of between 0.2 millimetres and 2 millimetres.

24. An inductor arrangement according to any one of claims 20-23, comprising a printed circuit board, wherein the support is a non-electrically-conductive substrate of the printed circuit board and the first and second portions or partial annuli are tracks on the substrate.

25. An inductor assembly for use in an aerosol provision device, the inductor assembly comprising plural inductors according to any of claims 1-19 or comprising plural inductor arrangements according to any of claims 20-24.

26. A magnetic field generator for use in an aerosol provision device, the magnetic field generator comprising one or more inductors according to any of claims 1-19 or one or more inductor arrangements according to any of claims 20-24 or the inductor assembly according to claim 25.

27. A magnetic field generator for use in an aerosol provision device, the magnetic field generator comprising one or more inductors and an apparatus that is operable to pass a varying electrical current through the one or more inductors,
wherein the one or more inductors and the apparatus are configured to cause the generation of a magnetic field having a magnetic flux density of at least 0.01 Tesla.

28. The magnetic field generator according to claim 27,
wherein the, or each, inductor is according to any one of claims 1-19, or
wherein the magnetic field generator comprises one or more inductor arrangements according to any one of claims 20-24 and the one or more inductors of the magnetic field generator are of the respective one or more inductor arrangements.

29. An aerosol provision device, comprising:
a heating zone for receiving at least a portion of an article comprising aerosolisable material; and
a magnetic field generator according to any of claim 26, 27 or 28, wherein the magnetic field generator is configured to be operable to generate a varying magnetic field for use in heating at least part of the aerosolisable material of the article when the article is in the heating zone.

30. An aerosol provision device according to claim 29, wherein the, or each, inductor of the magnetic field generator at least partially encircles the heating zone.

31. An aerosol provision device according to claim 29 or 30, comprising a susceptor that is heatable by penetration with the varying magnetic field to thereby cause heating of the heating zone.

32. An aerosol provision device according to any of claim 29, 30 or 31, wherein the magnetic field generator is configured to be operable to generate plural respective varying magnetic fields independently of each other, for use in heating respective parts of the aerosolisable material of the article independently of each other.

33. An aerosol provision system, comprising an aerosol provision device according to any of claims 29-32 and the article comprising aerosolisable material, wherein the article comprising aerosolisable material is at least partially insertable into the heating zone.

34. A magnetic field generator for use in an aerosol provision device, the magnetic field generator comprising one or more inductors, one or more coils and an apparatus that is operable to pass a varying electrical current through the one or more inductors;
wherein when the apparatus passes a varying electrical current through the one or more inductors, a corresponding varying electrical current is induced in the one or more coils; and
wherein the one or more inductors and the apparatus are configured to cause the generation of a magnetic field having a magnetic flux density of at least 0.01 Tesla.

35. A magnetic field generator for use in an aerosol provision device, the magnetic field generator comprising:
one or more inductors;
an apparatus that is operable to pass a varying electrical current through the one or more inductors; and
electromagnetic shielding;
wherein the electromagnetic shielding is arranged between the one or more inductors and the apparatus, wherein the electromagnetic shielding is further arranged to at least partially surround the one or more inductors and/or the apparatus and wherein the one or more inductors and the apparatus are configured to cause the generation of a magnetic field having a magnetic flux density of at least 0.01 Tesla.
